(19) United States
(12) Patent Application Publication
(10) Pub. No.: US 2006/0041527 A1
(43) Pub. Date: Feb. 23, 2006

(54) Virtual file system

(76) Inventor: Aaron Fessler, Mendham, NJ (US)

Correspondence Address: FAY KAPLUN & MARCIN, LLP, 15O BROADWAY, SUITE 702, NEW YORK, NY, 10038, US

(21) Appl. No.: 11/196,617

(22) Filed: Aug. 3, 2005

Related U.S. Application Data
(60) Provisional application No. 60/598,571, filed on Aug. 3, 2004.

(51) Int. Cl. G06F 17/30

(52) U.S. Cl. 707/1

(57) ABSTRACT

Described is a method for storing a data file and creating a plurality of virtual files, wherein each virtual file is mapped to the data file. Individual metadata is then generated for each virtual file, the metadata corresponding to a shared file, wherein the data file is different from the shared file and at least one of the plurality of virtual files is offered on a network.

### PRIORITY CLAIM

This Application claims benefit of U.S. Provisional Patent Application Ser. No. 60/598,571 filed on Aug. 3, 2004, which is expressly incorporated herein, by reference.

### BACKGROUND INFORMATION

Recently, many forms of media (e.g., movies, songs, music videos, software titles, video games, etc.) have become readily available to users through a communications network, such as the Internet. The media is typically compressed and stored in a file (i.e., a media file). The media file may then be shared between computers which are linked together through a network (e.g., a peer-to-peer (“P2P”) network). That is, the media file may be downloaded onto one computer from another, where both computers are linked on the same network. File sharers may then play the downloaded media files on their computers and/or save the media files onto one or more storage devices in order to play them through another means. For example, a file sharer may download a popular movie from another file sharer within the P2P network, and then burn the movie onto a Digital Video Disc (“DVD”) in order to watch it on a television.

It is often fairly simple to become linked to a P2P network, and thus to access shared media files. P2P networks are typically accessible through the Internet. Examples of former eDonkey®, BitTorrent®, etc. P2P networks typically require a file sharer to download software of a client, which enables the file sharer to offer and download media files. That is, file sharers may store media files in a database (e.g., a file folder) where the media files may be copied by other file sharers and the file sharers may copy the media files of the other file sharers through the client. Many clients also provide file sharers with a means of searching for a desired media file within the P2P network. Accordingly, the desired media file may be quickly and easily located and copied. P2P networks may become popular rather quickly, and the number of file sharers on a particular P2P network may increase dramatically. Thus, the number of media files which are shared on the P2P network also increases rather rapidly.

Many clients provide P2P network services free of cost to the file sharers. Many file sharers, now equipped with an ability to obtain media files quickly, easily, and free of cost, may be less inclined to purchase the media. Accordingly, producers (i.e., musical artists, film makers, etc.), who expect to receive a profit from sales of their material, are understandably upset. Thus, producers and P2P network file sharers may have a conflict of interest. Further, many of the media files shared through a P2P network client may be reproductions of copyrighted material. Thus, some forms of P2P sharing may be illegal if they amount to copyright infringement.

An owner of the copyrighted material which is compressed into the media files may wish to secure the material. That is, the owner may wish to prevent illegal file sharing. Because the media files are typically stored on the personal computers of file sharers, it may be difficult to prevent each file sharer from offering and/or downloading the media files. Further, as P2P clients gain popularity, a number of file sharers may increase exponentially. It may thereby become nearly impossible to monitor activities of each individual file sharer, and similarly impractical to restrain each individual file sharer from illegal media sharing. Thus, a more effective method of deterring illegal media sharing is currently desired.

### SUMMARY OF THE INVENTION

A method for storing a data file and creating a plurality of virtual files, wherein each virtual file is mapped to the data file. Individual metadata is then generated for each virtual file, the metadata corresponding to a shared file, wherein the data file is different from the shared file and at least one of the plurality of virtual files is offered on a network.

A system having a first storage area storing a data file and a second storage area storing a plurality of virtual files, wherein each virtual file is mapped to the data file, each virtual file including metadata corresponding to a shared file, wherein the data file is different from the shared file. A file distribution arrangement transmits the data file when a user selects one of the virtual files for download.

A computing arrangement comprising a memory to store a set of instructions and a processor to execute the set of instructions. The set of instructions being operable to store a data file, create a plurality of virtual files, wherein each virtual file is mapped to the data file, generate individual metadata for each virtual file, the metadata corresponding to a shared file, wherein the data file is different from the shared file and offer at least one of the plurality of virtual files on a network.

### BRIEF DESCRIPTION OF THE DRAWINGS

FIG. 1 shows an exemplary embodiment of a system according to the present invention, as compared to an alternative data structure.

FIG. 2 shows an exemplary embodiment of a system according to the present invention.

FIG. 3 shows another exemplary embodiment of a system according to the present invention.

FIG. 4 shows another exemplary embodiment of a system according to the present invention.

FIG. 5 shows an exemplary embodiment of a method according to the present invention.

FIG. 6 shows an exemplary embodiment of another method according to the present invention.

### DETAILED DESCRIPTION

The present invention may be further understood with reference to the following description and the appended drawings, wherein like elements are provided with the same reference numerals. The present invention relates to a Virtual File System (“VFS”) which creates a plurality of virtual files. Every virtual file may reference one or more real files, which contain data to be shared on a network (e.g., a peer-to-peer (“P2P”) network). Accordingly, it may appear to a file sharer that a number of various files are being offered on the network although many or all of the files reference a single real file.

Although the present invention will be described below with respect to its use with a P2P network, it will be understood by those of skill in the art that the invention may be used with other network architectures. For example, the present invention may be used with a client/server network, a combined network of the client/server architecture and the P2P architecture, or another type of network. Further, the present invention may be described with respect to its implementation on a computer to deter file sharing by others using computers linked to a communications network. It should be understood by those of skill in the art that the computers may include various types of network devices (e.g., a cellular phone, a personal digital assistant, a mobile computing device, an internet appliance, etc.) through which media files may be shared.

In addition, the exemplary embodiments are described with reference to the protection of media files. However, there may be other types of files that may be protected using the present invention. For example, some P2P networks offer files such as software applications, games, etc. The present invention may also be used to protect these types of files.

In an exemplary embodiment of the present invention, the owner of the material may attempt to flood the P2P network with a multitude of bogus files to deter the illegal sharing of media files containing copyright protected material. That is, the owner may offer a multitude of files bearing a name of the desired media, but an actual content of the files may be something other than the desired media. For example, a file sharer may wish to download a movie, such as Spiderman II. Accordingly, the file sharer may perform a search for the movie (via a P2P network client), the search returning a list of hits. Many of the hits may be files actually containing a viewable and audible version of Spiderman II. However, many of the hits may be the bogus files offered by the owner. Thus, a file sharer who downloads one of the bogus files actually downloads undesired material (e.g., the movie with a distorted picture, the movie without audio, a movie trailer, a warning, advertisements, white noise, garbage files, etc.). If the file sharer continually attempts to download Spiderman II, and yet continually downloads the same or various bogus files, the file sharer may become frustrated. Accordingly, the file sharer may cease attempting to download the movie illegally and/or may purchase the movie lawfully. Thus, flooding a P2P network with bogus files may protect copyrighted material because it may be prohibitive of illegal file sharing.

Although flooding a P2P network with bogus files may be rather beneficial to the owner of the copyrighted material, it may also in some respects be detrimental. For example, each bogus file may be between approximately 3 Mbs and 10 Gb, depending on a type, quality, and length of the file. In order to prohibit illegal file sharing, the owner may have to upload enough of the bogus files to sustain a likelihood that file sharers will select a bogus file from the list of hits returned, as opposed to selecting an actual file. That is, it may be preferable for the owner to offer a number of bogus files that is at least comparable to a number of actual files offered on the P2P network. It may be even more preferable to upload a number of bogus files which drastically outnumbers the number of actual files, thereby almost guaranteeing that a file sharer will select a bogus file for download. However, as the owner offers an increased number of bogus files, an increased amount of storage on the owner's database is consumed. Thus, flooding the P2P network to deter illegal sharing may come at a substantial cost. The exemplary embodiments of the present invention are described with reference to the owner of the copyrighted material, but may also be implemented by a third party. In most instances, the third party will be hired by the owner to protect the copyrighted material.

According to an exemplary embodiment of the present invention, the owner may offer any number of bogus files while only consuming an amount of storage space approximately equivalent to a storage space required for one bogus file. Any number of virtual files may be mapped to one real file (i.e., the one bogus file). Once created, the virtual files may be individually named and shared on a P2P network. When a file sharer selects and downloads a virtual file, the file sharer actually downloads bogus content which is contained within the one real file.

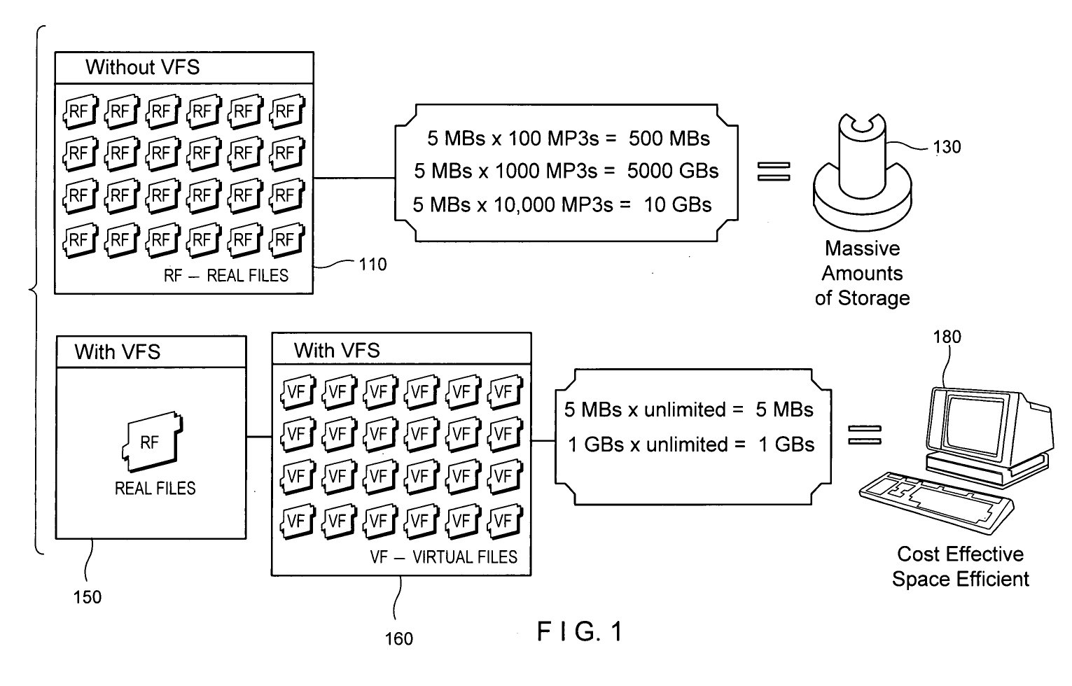

FIG. 1 shows a comparison of the storage space 130 which may be occupied by a plurality of real files 110, and the storage space 180 which may be occupied by a plurality of virtual files 160. Each of the virtual files 160 is mapped to one real file 150. As shown, the storage space 130 necessary to store the plurality of real files 110 increases dramatically as the plurality of real files 110 increases. In contrast, the storage space 180 necessary to store the plurality of virtual files 160 remains constant, despite an addition of virtual files to the plurality 160. Therefore, an unlimited number of virtual files may be offered by the owner on the P2P network, while only a minimal amount of storage space is required.

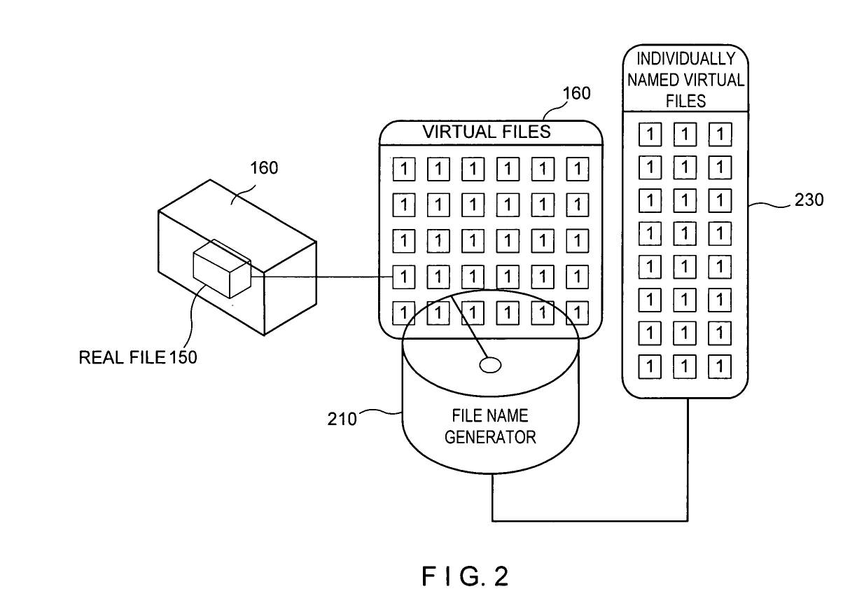

FIG. 2 shows an exemplary embodiment of a Virtual File System (“VFS”) of the present invention. The VFS may include at least one real file 150 and a plurality of virtual files 160. Each virtual file 160 is mapped to the real file 150. The VFS may further include a file name generator 210, which may be used to individually name each virtual file 160. The file name generator 210 supplies each virtual file with metadata information appropriate for the P2P network, e.g., an encoder, a title, adjectives, and a file extension. The individually named virtual files 230 may then be offered on a P2P network. Thus, the VFS gives an impression that files of different types are being offered, when actually each virtual file 160 is mapped to the one real file 150.

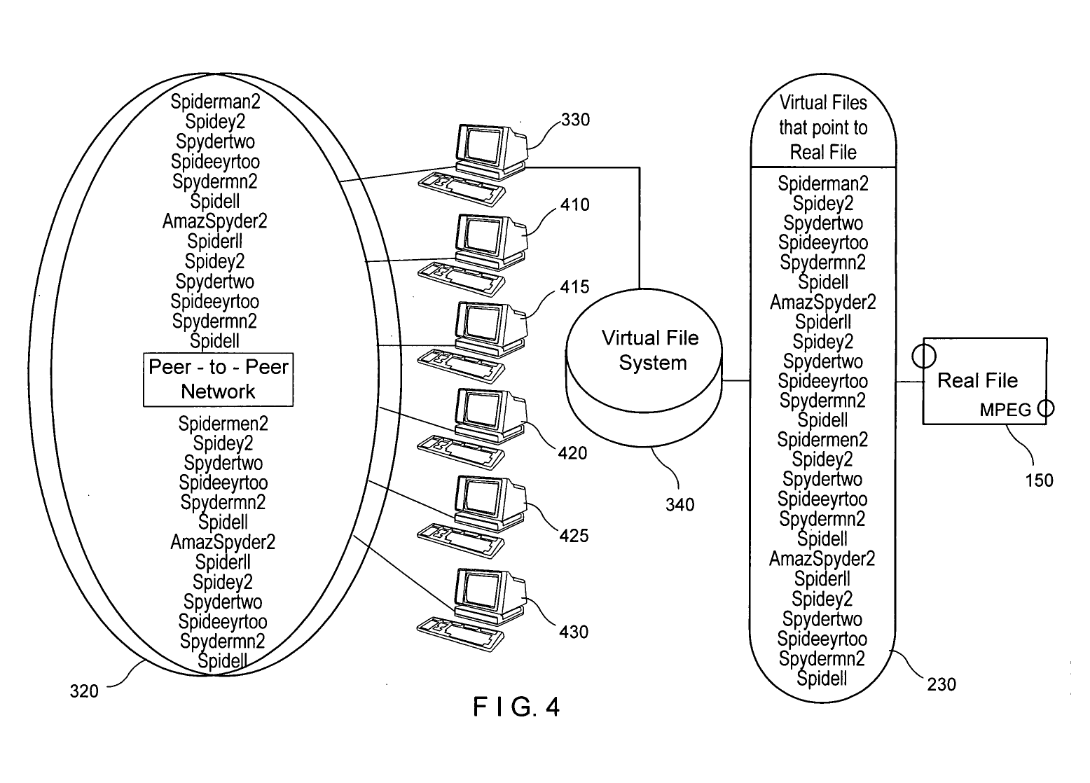

The title supplied by the file name generator 210 may be unique to each virtual file 160. For example, different visual representations (e.g., spellings, variations, abbreviations, slang terms, etc.) of a media file name may be generated and assigned to the virtual files 160. For example, as shown in FIG. 4, the VFS 340 may produce a number of different spellings (virtual filenames) for the movie Spiderman II. In one embodiment of the present invention, the file name generator 210 may generate the titles based on titles of other media files offered on the P2P network 320 by other file sharers. In another embodiment, the owner may provide a series of virtual filenames that should be used to protect the copyrighted material.

The file name generator 210 may also provide unique file extensions (e.g., .exe, .mp3, .avi, .rar, .zip, .tar, etc.) for each of the virtual files 160. Any file extension may be assigned to the virtual files 160 regardless of a file type of the one real file 150. Further, the file extensions may be generated as a function of those offered on the P2P network 320 by the other file sharers. For example, if sixty percent of the media files offered on the P2P network by the other file sharers are “.mpeg” files, and thirty percent of the files offered are “.avi”, the file name generator 210 may produce file extensions in a similar ratio.

It will be understood by those of skill in the art that the file name generator 210 may be configured to include additional metadata information for each virtual file 160. The additional metadata information may vary to match parameters of the P2P client. For example, when a file sharer performs a search, a client may return search results including data such as a file size, a file sharer's username, etc. Accordingly, each virtual file 160 may be given a file size which is appropriate for the type of media file represented by the virtual file 160. For example, a virtual file 160 posing as a version of a movie may indicate that the file is 900 Mbs, despite the actual file size of the real file 150. Further, the VFS may assign a username to each virtual file 160, thereby giving an impression that the virtual files 160 are offered by a variety of file sharers. Those of skill in the art will understand that the file name generator 210 may be configured to provide any type of metadata for a virtual file. The particular type of metadata will be determined by the P2P client for which the VFS is being used.

Once the virtual files 160 are individually named, they may be stored on the owner's computer. In one embodiment of the present invention, the individually named virtual files 230 may be stored in a Virtual Shared File folder. The Virtual Shared File folder may be accessed by file sharers attempting to download one of the virtual files 230. The individually named virtual files 230 may thus be offered on a P2P network, and may give an impression that they are all independent files, i.e., the virtual files 230 will appear to be multiple real files which include specific content. However, the virtual files 230 are actually a link to the one real file 150.

In P2P networks, file sharers may request desired media files. For example, the file sharer (via the P2P client) may enter a search term which corresponds to a title of the desired media file. Accordingly, a list of hits may be returned to the file sharer. In another example, a file sharer may access an index of another file sharer's stored media files and select the desired media file. Once the desired media file is located, it may be copied from a terminal on which it is located onto another terminal. For example, one file sharer connected to a network may determine that another file sharer is storing a desired media file on a computer which is also connected to the network. Accordingly, the one file sharer may download the media file.

In a conventional P2P network, a computer used by a file sharer may include an operating system (e.g., Microsoft Windows®) which facilitates file sharing by performing a number of specified tasks. For example, the operating system may fulfill a file sharer's request for a media file if the media file is stored within a shared folder. According to the present invention, a computer used by the owner additionally includes a Virtual File System, which may deter illegal file sharing as described below. The Virtual File System may work on any operating system, and thus may be installed on a wide variety of computers.

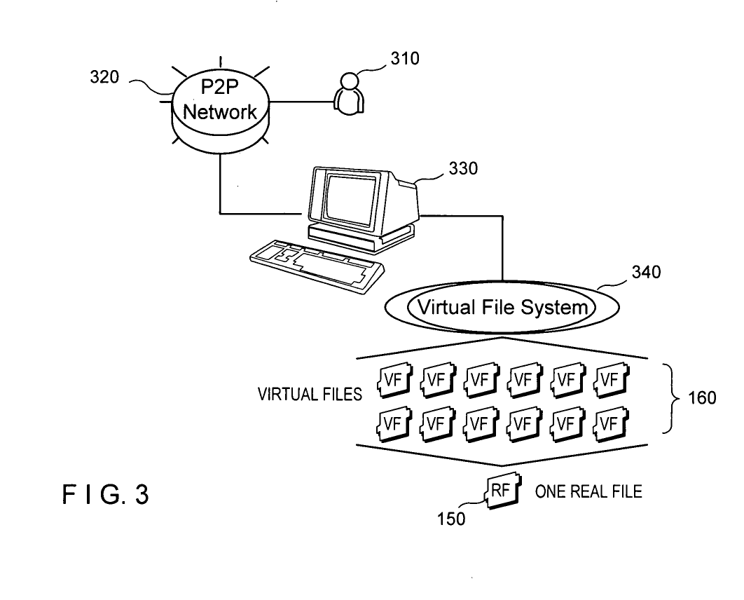

FIG. 3 shows an exemplary system where a file sharer 310 may ultimately download the one real file 150. The file sharer 310 may connect to a P2P network 320 through a client. Also connected to the P2P network 320 may be a number of other file sharers, including an owner's computer 330 on which the Virtual File System 340 is installed. The file sharer 310 may then request a desired media file which is stored on the computer 330. Thus, the file sharer 310, and/or the P2P client, may attempt to access a shared folder on the computer 330 in order to download the desired media file. The operating system of the computer 330 may attempt to fulfill the file sharer's request. However, the VFS 340 may intercept the request and fulfill the request with one of the virtual files 160, which is mapped to the real file 150.

In one exemplary embodiment of the present invention, the VFS 340 may be a programming device, such as a device driver. The VFS 340 may be created in any programming language (e.g., C, C++, Java, Unix, etc.) as a third party application (i.e., a plug-in) to a decoy file sharing program application. Examples of decoy file sharing program applications, which may be used to prevent the distribution of unlicensed digital media, may include the MediaScan, MediaExchange, and MediaDecoy distributed by MediaSentry of New York, N.Y.

FIG. 4 shows another exemplary embodiment of a system wherein the owner may implement the VFS 340. File sharers 410, 415, 420, 425, 430 may be connected to the P2P network 320. The file sharers 410-430 may offer media files for sharing on the P2P network 320 and/or they may seek to obtain media files offered by other file sharers. As shown, the computer 330, on which the VFS 340 is installed, is also connected to the P2P network 320. The computer 330 may offer a quantity of individually named virtual files 230 on the P2P network 320. The individually named virtual files 230 are all mapped to the one real file 150. In one embodiment of the present invention, the individually named virtual files 230 and/or the one real file 150 may be stored within a memory of the computer 330. In another embodiment, the individually named virtual files 230 may be dynamically created and named each time one of the file sharers 410-430 requests to find a particular media file. This will be described in more detail below.

Multiple media files may be offered on the P2P network 320 by the file sharers 410-430 and the owner. However, of the media files offered, a quantity may be the individually named virtual files 230 created by the VFS 340 and offered via the computer 330. As mentioned above, the quantity of individually named virtual files 230 may be comparable to a quantity offered by the other files sharers 410-430, or it may be far in excess thereof. Accordingly, the file sharers 410-430 sustain a high probability of selecting one of the individually named virtual files 230 for downloading.

Those of skill in the art will understand that the computer 330 may be a series of computers and/or other computing devices (e.g., servers) which may be used to protect any number of owner files. For example, an owner may have ten movie files that they want to protect. The computer 330 may include virtual files for all ten movies, i.e., files with metadata that correspond to the ten movies. All these virtual files may be a link to a single real file or each virtual file for an individual movie may be a link to a real file for the particular movie (e.g., a trailer for the movie). Moreover, the exemplary embodiments of the present invention are being described with reference to owners protecting their copyrighted material. However, it may be that one or more owners (e.g., recording companies, movie studios, etc.) contract with a third party provider of this type of service. The third party may have a series of computers 330 which protects a vast quantity of copyrighted material for these owners. In fact, the exemplary embodiments of the present invention enable such protection because it limits the actual amount of storage space needed to protect a vast quantity of copyrighted material.

Regardless of the quantity of individually named virtual files 230 offered by the computer 330, only a minimal amount of storage space is required. That is, offering an increased number of virtual files 230 does not increase a requisite storage space. In one embodiment of the present invention, the VFS 340 may allocate only enough storage space to store the real file 150.

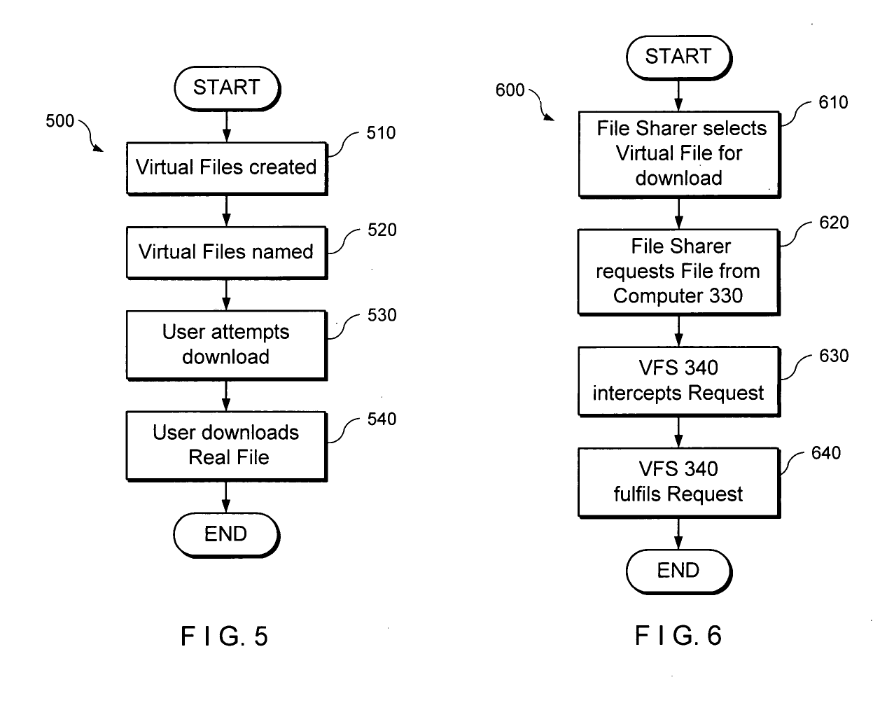

FIG. 5 shows a method 500 of deterring illegal file sharing according to the present invention. The method 500 will be described with respect to the exemplary systems of FIGS. 1-4. However, it will be understood by those of skill in the art that the method 500 may be applied to modified or alternative network architectures.

In step 510, the virtual files 160 are created. In one embodiment of the present invention, the virtual files may be created dynamically upon a request for a desired media file by one of the file sharers 310, 410-430. In another embodiment, the virtual files 160 may be created at a predetermined time and stored on the computer 330. For example, popular media files (e.g., newly released movies) may be requested by the files sharers 310, 410-430 at a very high frequency. Thus, generating a new plurality of virtual files 160 each time a file sharer 310, 410-430 makes a request may be impractical. Accordingly, it may be desirable to create the virtual files 160 at the predetermined time, and to periodically update the quantity of virtual files 160 offered on the P2P network 320 in relation to the quantity of media files offered by the file sharers 310, 410-430. In another example, a particular media file may be requested at a low frequency. In this case, the virtual files having metadata corresponding to the media file may only be created when the VFS detects a request for the media file.

In step 520, the virtual files 160 may be named. That is, names are generated by the file name generator 210 and assigned to each individual virtual file 160. The names may include a title, a file extension, an objective, an encoder, and any other data (e.g., file size, username, etc.) which may be required by the client. The virtual files 160 may be named upon creation or at another point in time. Further, the virtual files 160 may be periodically renamed in order to more closely resemble the filenames offered on the P2P network 320 by other file sharers 310, 410-430.

Once the virtual files 160 are named, they may be offered on the P2P network 320 among a quantity of media files offered by the other file sharers 310, 410-430. For example, the individually named virtual files 230 may be stored in a Virtual File Folder, which is accessible by the file sharers 310, 410-430. The exemplary embodiments of the present invention is described with reference to a file folder and/or a file system. However, those of skill in the art will understand that the present invention may be implemented using any other type of programming construct that may include the storage of the virtual files such as databases, programs, libraries, arrays, tables, etc.

Because each virtual file carries a different name, it may appear to the file sharers 310, 410-430 that the virtual files are actual files which are being offered by a plurality of other file sharers on the P2P network 320. Thus, the file sharers 310, 420-430 may decide to download one of the individually named virtual files while believing that the file is an actual copy of the requested media offered by another file sharer.

In step 530, a file sharer 310, 410-430 attempts to download a selected media file. Exemplary details of this step are described below with respect to FIG. 6. In step 540, the file sharer 310, 410-430 downloads the real file 150. Accordingly, the file sharer 310, 410-430 may open the file 150 to run the contents, thereby discovering that the real file 150 is actually bogus. Thus, the file sharer's 310, 410-430 attempt to illegally download copyright protected media has failed.

FIG. 6 shows an exemplary process 600 which may occur when the file sharer 310, 410-430 attempts to download one of the virtual files 230. The process 600 will be described with respect to the exemplary embodiments of FIGS. 1-4. However, it will be understood by those of skill in the art that the process 600 may be applied to other systems.

In step 610, the file sharer 310, 410-430 selects a virtual file 230 that is offered on the P2P network. That is, the file sharer 310, 410-430 reviews a list of media files offered and decides to download the virtual file 230. The list of media files may be the hits returned from a search request and/or an index of another file sharer's media files stored within a folder. The file sharer 310, 410-430 may perform a predetermined operation to indicate a desire to download the file, the predetermined operation may depend on parameters of the P2P client. For example, the file sharer 310, 410-430 may double-click the filename, drag-and-drop a file icon into a separate folder, highlight the listing and click “download”, etc.

In step 620, the file sharer 310, 410-430 requests the file from the computer 330. The network entity (i.e., computer) used by the file sharer 310, 410-430 may directly connect to the computer 330 to perform the request. Alternatively or additionally, the request may be facilitated by the P2P client. For example, the P2P client may be installed on the computer of the file sharer 310, 410-430 and the computer 330. The client may include parameters wherein downloaded media files are stored within a default file which is accessible by all entities connected to the P2P network. Accordingly, file sharer 310, 410-430 may access the default shared file of the computer 330, via the client, and copy selected media files.

In step 630, the VFS 340 intercepts the file request. That is, rather than allowing a file sharer 310, 410-430 to access a shared media file, as may occur on a system without a Virtual File System installed, the VFS 340 diverts the request. The VFS 340 may divert the request to a separate database (e.g., the Virtual File Folder), where all of the individually named virtual files 230 may be stored.

In step 640, the VFS 340 fulfills the request for the selected virtual file. As such, the VFS 340 performs similarly to an operating system of a conventional networked computer. That is, the VFS 340 allows the file sharer 310, 410-430 to retrieve and download the selected virtual file from the Virtual File Folder. However, because the virtual file merely points to the one real file 150, the file sharer 310, 410-430 receives a copy of the one real file 150.

As mentioned above, as the plurality of virtual files 160 offered on the network 320 increases, the possibility of a file sharer 310, 410-430 downloading a bogus media file also increases. Thus, a file sharer 310, 410-430 may attempt several downloads and each time receive the real file 150. After selecting and downloading a number of bogus media files (i.e., the real file 150), the file sharer 310, 410-430 may become frustrated and cease attempting to illegally download the media file. The property of the owner is thereby be protected.

Some P2P clients incorporate a feature which enables a file sharer 310, 410-430 to view the contents of a downloaded media file prior to completion of the download. That is, for example, if a file sharer 310, 410-430 is downloading a movie, and the download is only 25% complete, the file sharer 310, 410 430 may be able to view a first quarter of the movie. This may provide enough information for the file sharer 310, 410-430 to determine that the downloaded file is bogus, cancel the download, and select a new media file to download. However, the VFS 340 may prevent this feature from decreasing its effectiveness in several respects. For example, a predetermined portion of the real file 150 may contain an actual, undistorted version of the desired media. Accordingly, the file sharer 310, 410-430 may open a portion of the media before completion of the download and not be able to determine that a remaining portion of the downloaded media is bogus. In a further example, the VFS 340 may prevent the file sharer 310, 410-430 from opening a portion of the downloaded media file before the download is complete. Therefore, the file sharer 310, 410-430 may have to wait until the download was complete before determining that the media file was bogus. Thus, the file sharer may waste a substantial amount of time by downloading bogus files and thereby become increasingly frustrated. After wasting enough time, the file sharer may ultimately abandon any attempts of illegal file sharing.

The present invention may prove most useful with respect to deterring illegal sharing of media files which are in a peak demand. Many media files may be popular, and thus in high demand, for a short duration. For example, a newly released movie may only be in high demand between approximately several months to a year. Thus, a maximum number of file sharers may be deterred from downloading the media file if the VFS 340 of the present invention is applied during this time. The present invention may also be particularly beneficial with respect to larger media files which take a longer time to download, such as movies, video games, etc. File sharers may be less patient to find an uncorrupted media file when each media file takes more than 30 minutes to download. That is, a file sharer is likely to cease illegal sharing after a fewer number of attempted and failed downloads if the download time is relatively long.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
storing a data file;
creating a plurality of virtual files, wherein each virtual file is mapped to the data file;
generating individual metadata for each virtual file, the metadata corresponding to a shared file, wherein the data file is different from the shared file; and
offering at least one of the plurality of virtual files on a network.

2. The method of claim 1, further comprising:
transmitting the data file to a user of the network when the user requests one of the plurality of virtual files.

3. The method of claim 1, wherein the data file is a corrupted version of the shared file.

4. The method of claim 1, wherein the network is a peer-to-peer network.

5. The method of claim 1, wherein the shared file is a media file.

6. The method of claim 1, further comprising:
displaying the metadata for each virtual file when the metadata matches a search criteria.

7. The method of claim 1, wherein the metadata includes one of
a title, a file size, a file extension, and a file sharer name.

8. The method of claim 1, wherein the metadata is based on network information.

9. The method of claim 8, wherein the network information is one of a type of information on the network and a quantity of information on the network.

10. The method of claim 1, wherein the metadata is generated only after receiving a search request from a user.

11. A system, comprising:
a first storage area storing a data file;
a second storage area storing a plurality of virtual files, wherein each virtual file is mapped to the data file, each virtual file including metadata corresponding to a shared file, wherein the data file is different from the shared file; and
a file distribution arrangement to transmit the data file when a user selects one of the virtual files for download.

12. The system of claim 11, further comprising:
a virtual file selector to select virtual files including metadata matching a received search criteria.

13. The system of claim 11, wherein the first and second storage areas are file folders of an operating system.

14. The system of claim 11, wherein the data file is a corrupted version of the shared file.

15. The system of claim 11, wherein the data file is transmitted via a peer-to-peer network.

16. The system of claim 11, wherein the shared file is a media file.

17. The system of claim 1, wherein the metadata includes one of a title, a file size, a file extension and a file sharer name.

18. A computing arrangement comprising a memory to store a set of instructions and a processor to execute the set of instructions, the set of instructions being operable to:
store a data file;
create a plurality of virtual files, wherein each virtual file is mapped to the data file;
generate individual metadata for each virtual file, the metadata corresponding to a shared file, wherein the data file is different from the shared file; and
offer at least one of the plurality of virtual files on a network.

19. The computing arrangement of claim 18, wherein the metadata includes one of a title, a file size, a file extension and a file sharer name.
